(19) United States
(12) Patent Application Publication
(10) Pub. No.: US 2011/0082941 A1
(43) Pub. Date: Apr. 7, 2011

(54) METHOD OF PROVIDING DIRECT COMMUNICATION IN INTERNET PROTOCOL NETWORK

(75) Inventors: Sun Cheul Kim, Daejeon (KR); Seong Moon, Daejeon (KR); Ho Yong Ryu, Daejeon (KR); Kyeong Ho Lee, Daejeon (KR); Soon Seok Lee, Daejeon (KR)

(73) Assignee: Electronics and Telecommunications Research Institute, Daejeon (KR)

(21) Appl. No.: 12/898,929

(22) Filed: Oct. 6, 2010

(30) Foreign Application Priority Data
Oct. 6, 2009 (KR) 10-2009-0094783
Aug. 23, 2010 (KR) 10-2010-0081568

(51) Int. Cl. G06F 15/16

(52) U.S. Cl. 709/227

(57) ABSTRACT

In order for a peer node to perform direct communication with a correspondent peer node in an Internet protocol network, the peer node receives a virtual address of the correspondent peer node from a server, and then when the peer node can directly set a tunnel with the correspondent peer node, the peer node sets a tunnel with the correspondent peer node, and when the peer node cannot directly set a tunnel with the correspondent peer node, the peer node sets a tunnel with a tunnel repeater. Thereafter, the peer node connects a virtual address of the correspondent peer node as route information to the tunnel. Thereby, a packet using a virtual address of the correspondent peer node as a destination is transmitted to the correspondent peer node through a predetermined tunnel.

### CROSS-REFERENCE TO RELATED APPLICATION

This application claims priority to and the benefit of Korean Patent Application No. 10-2009-0094783 and 10-2010-0081568 filed in the Korean Intellectual Property Office on Oct. 6, 2009 and Aug. 23, 2010, the entire contents of which are incorporated herein by reference.

### BACKGROUND OF THE INVENTION

(a) Field of the Invention

The present invention relates to a method of providing direct communication in an Internet protocol (IP) network.

(b) Description of the Related Art

An IP network uses a firewall or a network address translation (NAT) in order to interrupt access from the outside, or due to insufficiency of an IP. In such an environment, there have been many efforts to apply peer-to-peer (P2P) technology to services such as games and messenger tools in communication markets.

An IP network including a NAT or a firewall provides direct communication of a P2P Layer 4 (L4) level through help of a server. In order to perform a P2P direct communication, each terminal should determine a network connection type thereof. When a terminal connects to a public network, the terminal should determine whether a firewall exists, and when a terminal connects to a network using a NAT, the terminal should determine the NAT type.

When a network has no firewall, the network is referred to as an open network. NAT types include a full cone NAT, a restricted cone NAT, a port restricted cone NAT, and a symmetric NAT.

Table 1 represents a direct communication possibility between a receiver and a sender without help of a server in an existing IP network. In Table 1, “Open” indicates an open network, and “Firewall” indicates the presence of a firewall.

TABLE 1

| | | Sender | | | | | |
|---|---|---|---|---|---|---|---|
| | | | | NAT | | | |
| | | Public | | | | Port | |
| | | | Fire- | Full | Restricted | restricted | Sym- |
| Receiver | | Open | wall | cone | cone | cone | metric |
| Public | Open | ◯ | ◯ | ◯ | ◯ | ◯ | ◯ |
| | Firewall | X | X | X | X | X | X |
| NAT | Full cone | X | X | X | X | X | X |
| | Restricted | X | X | X | X | X | X |
| | cone | | | | | | |
| | Port | X | X | X | X | X | X |
| | restricted | | | | | | |
| | cone | | | | | | |
| | Symmetric | X | X | X | X | X | X |

As shown in Table 1, when a receiver is Public-Open, direct communication can be performed between a sender and a receiver.

However, when a NAT or a firewall intervenes between a sender and a receiver, the sender and the receiver can perform communication when acquiring a changed IP and port information of another terminal through help of a server.

Table 2 represents a direct communication possibility between a receiver and a sender when acquiring a changed IP and port information of another terminal from a server.

TABLE 2

| | | Sender | | | | | |
|---|---|---|---|---|---|---|---|
| | | | | NAT | | | |
| | | Public | | | | Port | |
| | | | Fire- | Full | Restricted | restricted | Sym- |
| Receiver | | Open | wall | cone | cone | cone | metric |
| Public | Open | ◯ | ◯ | ◯ | ◯ | ◯ | ◯ |
| | Firewall | X | X | X | X | X | X |
| NAT | Full cone | ◯ | ◯ | ◯ | ◯ | ◯ | ◯ |
| | Restricted | X | X | X | X | X | X |
| | cone | | | | | | |
| | Port | X | X | X | X | X | X |
| | restricted | | | | | | |
| | cone | | | | | | |
| | Symmetric | X | X | X | X | X | X |

In Table 2, even in a case where a sender and a receiver acquire a changed IP and port information of another terminal with the help of a server, only when the receiver is Public-Open and NAT-Full cone can direct communication be performed between the sender and the receiver.

Further, for direct communication between the sender and the receiver, TCP or UDP hole punching may be performed. Table 3 represents a direct communication possibility between a receiver and a sender after performing hole punching using a changed IP and port information of another terminal from a server. In Table 3, “▴” represents that direct communication can be performed only in a case where an IP is not changed and only a port is changed when one of a sender and a receiver uses NAT-Symmetric and that direct communication cannot be performed when another node is a NAT-Restricted Cone even in a case where an IP is changed.

TABLE 3

| | | Sender | | | | | |
|---|---|---|---|---|---|---|---|
| | | | | NAT | | | |
| | | Public | | | | Port | |
| | | | Fire- | Full | Restricted | restricted | Sym- |
| Receiver | | Open | wall | cone | cone | cone | metric |
| Public | Open | ◯ | ◯ | ◯ | ◯ | ◯ | ◯ |
| | Firewall | ◯ | ◯ | ◯ | ◯ | ◯ | X |
| NAT | Full cone | ◯ | ◯ | ◯ | ◯ | ◯ | ◯ |
| | Restricted | ◯ | ◯ | ◯ | ◯ | ◯ | ▴ |
| | cone | | | | | | |
| | Port | ◯ | ◯ | ◯ | ◯ | ◯ | X |
| | restricted | | | | | | |
| | cone | | | | | | |
| | Symmetric | ◯ | X | ◯ | ▴ | X | X |

In Table 3, even if hole punching is performed, in all interface types of a sender and a receiver, direct communication may not be performed between a sender and a receiver. That is, it can be seen that direct communication cannot be performed between NAT-Symmetric and NAT-Symmetric, between NAT-Symmetric and Public-Firewall, and between NAT-Symmetric and NAT-Port Restricted Cone.

However, even in such a case, direct communication can be performed using a traversal using relay NAT (TURN). The TURN allows direct communication to be performed through a device that is connected to Public-Open. That is, in order to perform communication with another terminal, each of a sender and a receiver transmits data to a device that is connected to Public-Open, and the device can perform direct communication by deforming a packet and transmitting data to another terminal.

In this way, because a method of allowing to perform direct communication between a sender and a receiver should be performed on a service basis, i.e., in each Layer 4 (L4) session, when a plurality of sessions operate for direct communication in one terminal, frequent processing procedures occur. Further, because such direct communication method is technology that is applied to only P2P, technology that can provide direct communication between network Peer-to-Network (P2N) or Network-to-Network (N2N) is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method of providing direct communication in an IP network having advantages of allowing to perform direct communication between Peer-to-Peer (P2P), Peer-to-Network (P2N), or Network-to-Network (N2N) in an IP network in which a firewall or a NAT exists.

The present invention has also been made in an effort to further provide a method of providing direct communication in an IP network having advantages of simplifying a processing procedure.

An exemplary embodiment of the present invention provides a method in which a peer node performs direct communication with a correspondent peer node in an IP network. The method includes: receiving a virtual address of the peer node from a server; transmitting a tunnel request message including an identifier of the another peer node to the server; receiving a tunnel response message including a virtual address of the another peer node corresponding to the identifier of the correspondent peer node from the server; setting a tunnel with the correspondent peer node; and connecting the virtual address of the correspondent peer node as route information to the tunnel.

Another embodiment of the present invention provides a method in which a server provides direct communication between two peer nodes in an IP network. The method includes: determining a network connection type of the two peer nodes; determining whether direct communication can be performed between the two peer nodes from the network connection type of the two peer nodes; transmitting, if direct communication can be performed between the two peer nodes, tunnel information corresponding to a destination of a tunnel to the two peer nodes in order to set the tunnel between the two peer nodes; and transmitting a virtual address of a correspondent peer node to communicate as route information to connect to the tunnel to the two peer nodes. Yet another embodiment of the present invention provides a method in which a tunnel repeater provides direct communication of two peer nodes in an IP network. The method includes: receiving a first tunnel setting request message including a virtual address of a first peer node from the first peer node of the two peer nodes; receiving a second tunnel setting request message including a virtual address of a second peer node from the second peer node of the two peer nodes; extracting source addresses of the first and second tunnel setting request messages; setting a first tunnel using the source address of the first tunnel setting request message as a destination; setting a second tunnel using the source address of the second tunnel setting request message as a destination; connecting a virtual address of the first peer node as route information to the first tunnel; and connecting a virtual address of the second peer node as route information to the second tunnel.

### BRIEF DESCRIPTION OF THE DRAWINGS

FIG. 1 is a diagram illustrating an IP network for providing direct communication according to an exemplary embodiment of the present invention.

FIG. 2 is a flowchart illustrating a method of allocating a virtual address of a peer node in a server according to an exemplary embodiment of the present invention.

FIG. 3 is a flowchart illustrating a method of connecting a peer node to a server according to an exemplary embodiment of the present invention.

FIG. 4 is a diagram illustrating a server that is shown in FIG. 1.

FIG. 5 is a table illustrating an example of a storage unit that is shown in FIG. 4.

FIG. 6 is a flowchart illustrating a method of setting direct communication between peer nodes through a server according to an exemplary embodiment of the present invention.

FIG. 7 is a table illustrating an example of virtual addresses, network addresses, and NAT addresses of two peer nodes.

FIG. 8 is a flowchart illustrating a method in which two peer nodes set a tunnel with a tunnel repeater through a server according to an exemplary embodiment of the present invention.

FIG. 9 is a table illustrating an example of virtual addresses, network addresses, and NAT addresses of two peer nodes and an address of a tunnel repeater.

FIG. 10 is a flowchart illustrating a direct communication method between virtual hosts according to an exemplary embodiment of the present invention.

FIG. 11 is a table illustrating addresses of virtual networks in which two peer nodes have.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In addition, in the entire specification and claims, unless explicitly described to the contrary, the word “comprise” and variations such as “comprises” or “comprising” will be understood to imply the inclusion of stated elements but not the exclusion of any other elements.

Now, a method of providing direct communication in an IP network according to an exemplary embodiment of the present invention will be described in detail with reference to the drawings.

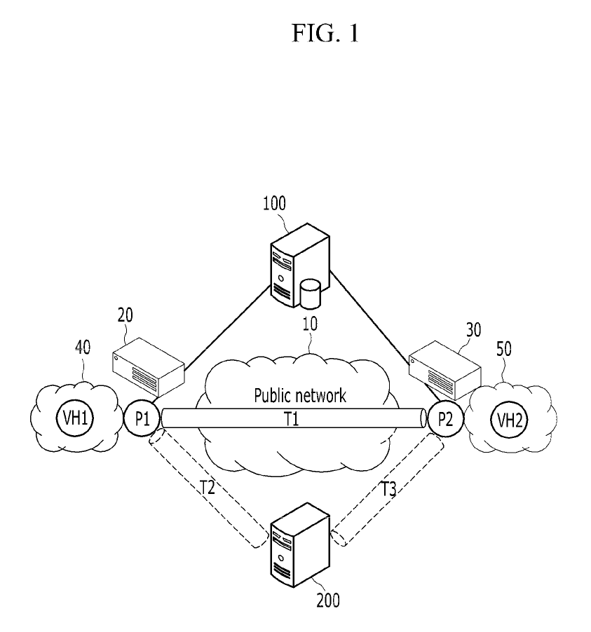

FIG. 1 is a diagram illustrating an IP network for providing direct communication according to an exemplary embodiment of the present invention.

Referring to FIG. 1, an IP network for providing direct communication includes peer nodes P1 and P2, a server 100, and a tunnel repeater 200. The peer nodes P1 and P2 can be connected to a firewall or network address translations (NAT) 20 and 30. In FIG. 1, the peer nodes P1 and P2 are connected to the NATs 20 and 30.

The server 100 and the tunnel repeater 200 are connected to a public network 10.

The server 100 manages a virtual address to be used by the peer nodes P1 and P2, and allocates the virtual address to the peer nodes P1 and P2. In this case, the server 100 determines whether the peer nodes P1 and P2 are ends host or devices having a network, allocates, if the peer nodes P1 and P2 are end hosts, a virtual IP to a virtual address, and allocates, if the peer nodes P1 and P2 are devices having a network, a network prefix and a prefix length as well as a virtual IP to the virtual address. As a virtual IP, an IPv4 address or IPv6 address can be used.

The server 100 manages network addresses of the peer nodes P1 and P2 and addresses of the peer nodes P1 and P2 in which the network addresses of the peer nodes, P1 and P2 are changed by the NATs 20 and 30. Hereinafter, addresses of the peer nodes P1 and P2 that are changed by the NATs 20 and 30 are referred to as NAT addresses, and each NAT address includes an IP and a port that are changed by the NATs 20 and 30.

The network address of the peer nodes P1 and P2 includes an IP that is received from a dynamic host configuration protocol (DHCP) server (not shown) when the peer nodes P1 and P2 are connected to a network, or a fixed IP that is received from a user.

The network address may be a private IP when the peer nodes P1 and P2 receive an IP by connecting to the NATs 20 and 30, or may be a public IP when the peer nodes P1 and P2 receive an IP by connecting to a public network 10. Further, when the peer nodes P1 and P2 are connected to the NATs 20 and 30, the NAT address may be an IP and a port that are changed by the NATs 20 and 30.

Further, for direct communication between the peer nodes P1 and P2, in order to set a tunnel T1 between the peer nodes P1 and P2 or tunnels T2 and T3 between the peer nodes P1 and P2 and the tunnel repeater 200, the server 100 performs a function of processing and relaying a signaling message that is received from the peer nodes P1 and P2.

When a direct tunnel cannot be set between the peer nodes P1 and P2, the tunnel repeater 200 processes a signaling message for setting the tunnels T2 and T3 with the peer nodes P1 and P2.

The peer nodes P1 and P2 are connected to the public network 10 through the NATs 20 and 30 as an end host.

The peer nodes P1 and P2 receive a network address from the public network 10, receive a virtual address from the server 100, and perform communication using a network address and a virtual address. Particularly, applications operating in the peer nodes P1 and P2 can perform communication with a virtual address.

Further, when the peer nodes P1 and P2 are connected to the server 100 through the NATs 20 and 30, the peer nodes P1 and P2 receive a NAT address thereof from the server 100.

The peer nodes P1 and P2 set a tunnel T1 between the peer nodes P1 and P2 or set tunnels T2 and T3 with the tunnel repeater 200 using a network address or a NAT address, and perform direct communication with correspondent peer nodes P2 and P1 to communicate through a predetermined tunnel.

For example, when the peer nodes P1 and P2 are connected to the NATs 20 and 30, the peer nodes P1 and P2 receive NAT addresses of other peer nodes P2 and P1 from the correspondent peer nodes P2 and P1, respectively, and thus set a tunnel with the correspondent peer nodes P2 and P1 using the NAT addresses of the correspondent peer nodes P2 and P1 as tunnel information.

When a direct tunnel cannot be set between the peer nodes P1 and P2, the peer nodes P1 and P2 receive an address of the tunnel repeater 200 to set a tunnel from the server 100, transmit NAT addresses thereof to the address of the tunnel repeater 200, and set a tunnel with the tunnel repeater 200 using the address of the tunnel repeater 200 as tunnel information, and the tunnel repeater 200 sets a tunnel with each of the peer nodes P1 and P2 using NAT addresses of the peer nodes P1 and P2 as tunnel information.

When a network prefix and a prefix length are included in a virtual address that is received from the server 100, the peer nodes P1 and P2 set virtual networks 40 and 50 based on the network prefix and the prefix length, and virtual hosts VH1 and VH2 are connected to the virtual networks 40 and 50, respectively. In this way, when the peer nodes P1 and P2 are devices having the virtual networks 40 and 50, not an end host, communication between the virtual hosts VH1 and VH2 that are positioned at the virtual networks 40 and 50 can be performed using a tunnel T1 that is set between the peer nodes P1 and P2, or using tunnels T2 and T3 that are set between the peer nodes P1 and P2 and the tunnel repeater 200.

The peer nodes P1 and P2 and the virtual hosts VH1 and VH2 may be various personal computer (PC) devices, various sensor devices, a smart phone device, and a video camera that perform IP-based communication. Particularly, when the peer nodes P1 and P2 form virtual networks 40 and 50, the peer nodes P1 and P2 may be devices having an Internet share function and a NAT function. The device having an Internet share function includes a NAT device, an access point (AP), various operating systems (OS), and a PC-based NAT device.

Further, the peer nodes P1 and P2 may be devices that use a signal of Ethernet, Wi-Fi, Wibro, high-speed downlink packet access (HSDPA), and 3G with a wide area network (WAN) connection and a signal of Ethernet, Wi-Fi, and Bluetooth with a local area network (LAN) connection. For example, when a smart phone having an Internet share function connects to the Internet using one of 3G, Wibro, and Wi-Fi and the smart phone provides a connection to various devices using Wi-Fi or Bluetooth communication, the smart phone may be a peer node having a virtual network, and the various devices connecting to the smart phone may be a virtual host.

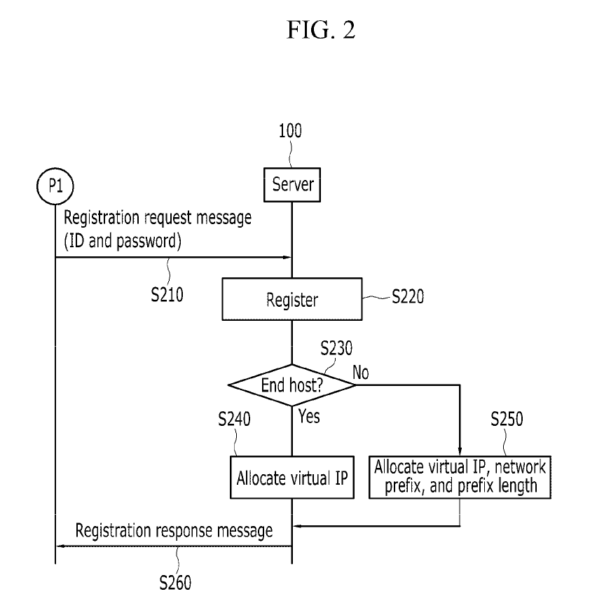

FIG. 2 is a flowchart illustrating a method of allocating a virtual address of a peer node in a server according to an exemplary embodiment of the present invention. FIG. 2 illustrates only one peer node P1.

Referring to FIG. 2, in order to register information such as an ID and a password to the server 100, the peer node P1 transmits a registration request message including an ID and a password to the server 100 (S210).

The server 100 registers information such as an ID and a password of the peer node P1 (S220). Here, the ID is an identifier that can distinguish the peer node P1 in the server 100 and is formed with a string.

Further, in order to allocate a virtual address to the peer node P1, the server 100 determines whether the peer node P1 is an end host or a device having a network (S230). In this case, if the peer node P1 is an end host, the server 100 allocates a virtual IP as a virtual address (S240), and if the peer node P1 is a device having a network, the server 100 allocates a network prefix and a prefix length as well as a virtual IP as a virtual address (S250).

Thereafter, the server 100 transmits a registration response message to a registration request message to the peer node P1 (S260). The server 100 may include a virtual address in the registration response message.

In this way, the server 100 allocates a virtual address of the peer node P1 by a registration request message of the peer node P1 and maps the allocated virtual address to an ID of the peer node, thereby managing the virtual address.

The peer node P1 receives a virtual address from the server 100 through a registration response message and requests a virtual address by connecting several times to the server 100, thereby receiving a virtual address from the server 100.

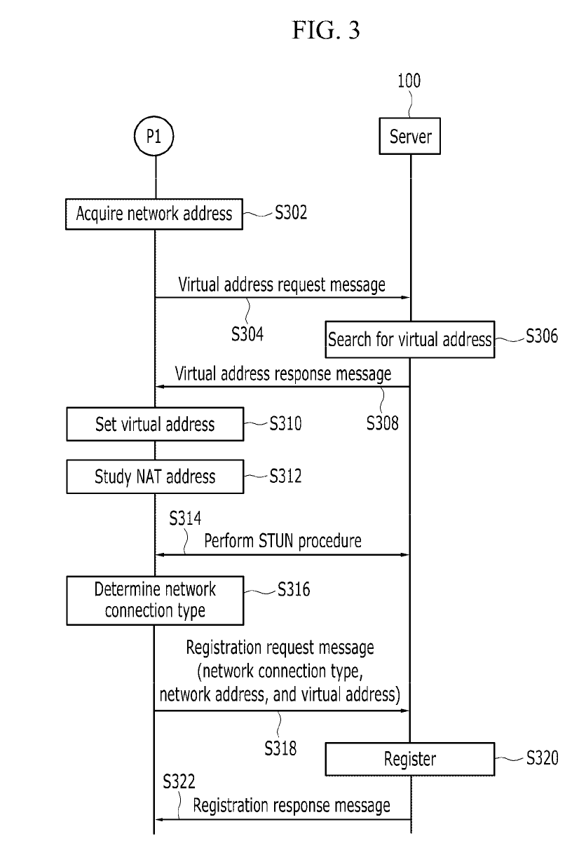

FIG. 3 is a flowchart illustrating a method of connecting a peer node to a server according to an exemplary embodiment of the present invention. FIG. 3 illustrates only one peer node P1.

Referring to FIG. 3, at the moment when the peer node P1 connects to the public network 10, the peer node P1 acquires a network address from the public network 10 (S302). For example, at the moment when the peer node P1 connects to the public network 10, the peer node P1 receives an IP corresponding to a network address from a DHCP server, or an IP corresponding to a network address from a user.

Next, the peer node P1 transmits a virtual address request message including an ID thereof to the server 100, thereby requesting a virtual address thereof from the server 100 (S304).

The server 100 having received a virtual address request message searches for a virtual address corresponding to an ID of the peer node P1 (S306), and includes the found virtual address in a virtual address response message to the virtual address request message and transmits the message to the peer node P1 (S308).

The peer node P1 sets a virtual address that is included in the virtual address response message to a tunnel interface (S310). That is, the peer node P1 connects a correspondent peer node (for example, P2 of FIG. 1) and a virtual address to a predetermined tunnel. Accordingly, the peer node P1 performs communication based on a virtual IP through a predetermined tunnel.

Next, when the peer node P1 sets a direct tunnel with the correspondent peer node (for example, P2 of FIG. 1), the peer node P1 studies a NAT address to use for UDP or TCP hole punching, i.e., the changed IP and port (S312), and in order to determine a network connection type thereof, the peer node P1 performs a simple traversal of user datagram protocol (UDP) through network address translators (NATs) [STUN] procedure with the server 100 (S314).

The peer node P1 determines a network connection type from a STUN procedure with the server 100 (S316), and in order to register a network connection type to the server 100, the peer node P1 transmits a registration request message including a network connection type together with a virtual address and a network address to the server 100 (S318).

The server 100 having received a registration request message maps a network connection type and a network address of the peer node P1 to a virtual address, and registers the network connection type and the network address (S320) and transmits a registration response message according to registration completion to the peer node P1 (S322).

In a STUN procedure, a port is used. A port used for the STUN procedure can be used in a response message to a virtual address request that is transmitted/received between the peer nodes P1 and P2 and the server 100, a registration response message to a registration request of network connection type information, a hole punching message used in order for the peer node (for example, P1 of FIG. 1) to set a direct tunnel with the correspondent peer node (for example, P2 of FIG. 1), and a tunnel request response message that is transmitted from the correspondent peer node (for example, P2 of FIG. 1).

Further, when the peer node P1 is connected to the NAT (20 of FIG. 1), in order to escape session timeout of the NAT (20 of FIG. 1), the peer node P1 can periodically transmit a message using a port corresponding to a network address to the server 100.

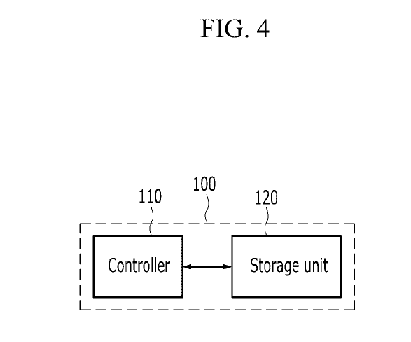

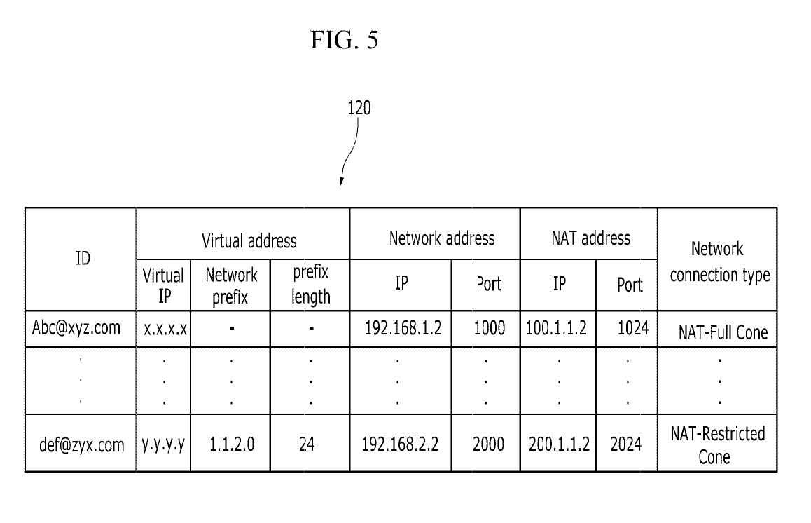

FIG. 4 is a diagram illustrating a server that is shown in FIG. 1, and FIG. 5 is a table illustrating an example of a storage unit that is shown in FIG. 4.

Referring to FIG. 4, the server 100 includes a controller 110 and a storage unit 120.

The controller 110 allocates a virtual address to the peer node P1, and stores a virtual address that is allocated to the peer node P1 in the storage unit 120.

Further, the controller 110 processes a registration request of a network address, a NAT address, and a network connection type from the peer node P1, and stores the network address, the NAT address, and the network connection type of the peer node P1 in the storage unit 120.

A virtual address, a network address, a NAT address, and a network connection type on an ID basis of the peer node P1 are stored in the storage unit 120. For example, as shown in FIG. 5, by mapping to an ID (abc@xyz.com, def@zyx.com) of a peer node, a virtual address, a network address, a NAT address, and a network connection type can be stored.

Alternatively, by mapping to a virtual address using a virtual address of the peer node P1 as a key, a network address, a NAT address, and a network connection type may be stored.

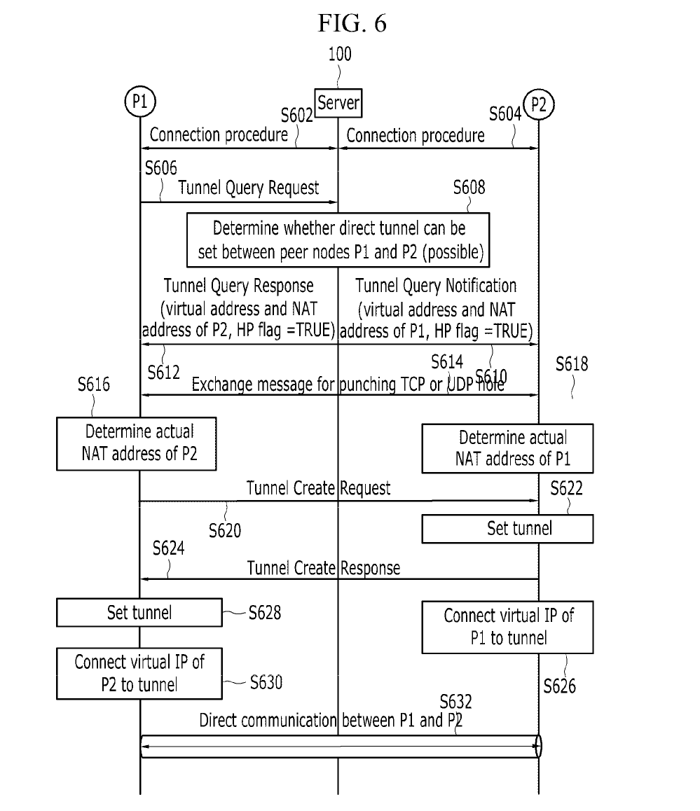

Next, a method of setting a tunnel for direct communication between two peer nodes P1 and P2 will be described in detail with reference to FIGS. 6 to 11. Hereinafter, for convenience of description, it is assumed that two peer nodes P1 and P2 are connected to the NATs 20 and 30, respectively.

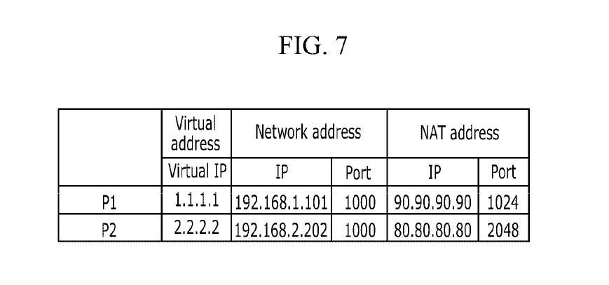

FIG. 6 is a flowchart illustrating a method of setting direct communication between peer nodes through a server according to an exemplary embodiment of the present invention, and FIG. 7 is a table illustrating an example of virtual addresses, network addresses, and NAT addresses of two peer nodes.

Referring to FIG. 6, the peer nodes P1 and P2 perform a connection procedure, as shown in FIG. 3 (S602-S604). Accordingly, the server 100 acquires network addresses, NAT addresses, and network connection types of the peer nodes P1 and P2.

Thereafter, in order to perform direct communication with the peer node P2, the peer node P1 performs a process of setting a tunnel with the peer node P2.

In order to set a tunnel for performing direct communication with the peer node P2, the peer node P1 transmits a tunnel query request message to the server 100 (S606). In this case, in the server 100, when forming the storage unit 120 based on an ID of peer nodes, a tunnel query request message includes an ID of the peer node P2 to communicate. Alternatively, in the server 100, when forming the storage unit 120 based on a virtual address of peer nodes, a tunnel query request message includes a virtual address of the peer node P2.

The server 100 having received the tunnel query request message determines whether a direct tunnel can be set between the peer nodes P1 and P2 from a network connection type of two peer nodes P1 and P2 (S608). For example, when a network connection type of two peer nodes P1 and P2 is NAT-Symmetric and NAT-Symmetric, NAT-Symmetric and Public-Firewall, and NAT-Symmetric and NAT-Port Restricted Cone, the server 100 determines that a direct tunnel cannot be set between the two peer nodes P1 and P2.

When a direct tunnel can be set between two peer nodes P1 and P2, the server 100 includes information in which a direct tunnel can be set between the two peer nodes P1 and P2 and tunnel information in a tunnel query notification message, and transmits the message to the peer node P2 (S610). Further, the server 100 includes information in which a direct tunnel can be set between the two peer nodes P1 and P2 and tunnel information in a tunnel query response message, and transmits the message to the peer node P1 (S612). Here, information in which a direct tunnel can be set between two peer nodes P1 and P2 is represented by setting a hole punching flag (HP flag). For example, by setting a hole punching flag to “TRUE”, information in which a direct tunnel can be set between two peer nodes P1 and P2 can be displayed. Further, tunnel information that is transmitted to the peer node P1 includes a virtual address, a network address, and a NAT address of the peer node P2 to communicate, and similarly, tunnel information that is transmitted to the peer node P2 includes a virtual address, a network address, and a NAT address of the peer node P1 to communicate.

The peer nodes P1 and P2, having received a tunnel query response message and a tunnel query request message, respectively, exchange a message for punching a TCP or UDP hole (S614). In this process, the peer node P1/P2, having received a message of the correspondent peer node extracts a source address from an IP header of the received message, and determines the extracted source address as an actual NAT address of the peer node P2/P1 (S616-S618).

Thereafter, the peer node P1 transmits a tunnel create request message to an actual NAT address of the peer node P2 as a destination (S620).

When the peer node P2 receives a tunnel create request message from the peer node P1, the peer node P2 extracts a source address from an IP header of the tunnel create request message and thus sets a tunnel using the source address as a destination address of the tunnel and uses a network address thereof as a source address (S622), and transmits a tunnel create response message including a virtual address thereof using a source address of the extracted IP header to the peer node P1 (S624).

Further, the peer node P2 is connected to a predetermined tunnel using a virtual IP of the peer node P1 as route information (S626). Thereby, all packets using a virtual IP of the peer node P1 as a destination are transmitted to the peer node P1 through a tunnel that is set by the peer node P2. The peer node P1, having received a tunnel create response message from the peer node P2, extracts a source address of the tunnel create response message, and thus sets a tunnel using the source address as a destination address of a tunnel, and using a network address thereof as a source address of the tunnel (S628).

Thereafter, the peer node P1 is connected to a predetermined tunnel using a virtual IP of the peer node P2 as route information (S630). Thereby, all packets using a virtual IP of the peer node P2 as a destination are transferred to the peer node P2 through a tunnel that is set by the peer node P1.

A source address of a tunnel create response message that is received by the peer node P1 may be to the same as an actual NAT address of the peer node P2 that is determined in TCP or UDP hole punching, and a source address of a tunnel create request message that is received by the peer node P2 may be the same as an actual NAT address of the peer node P1 that is determined in TCP or UDP hole punching. Therefore, actual NAT addresses of the peer nodes P1 and P2 that are determined in TCP or UDP hole punching may be used as tunnel information. After such a process is complete, applications of the peer nodes P1 and P2 can perform direct communication based on a virtual IP (S632). Further, a method of providing such direct communication is not provided on an application service basis, but a communication environment of an L3 level is provided on a peer node basis, and thus all applications operating in each of the peer nodes P1 and P2 allow a multi-service that can perform direct communication.

For example, as shown in FIG. 7, when it is assumed that a peer node P1 in which a network address IP/port is 192.168.1.101/1000 and in which a NAT address IP/port is 90.90.90.90/1024, and in which a virtual IP is 1.1.1.1 and a peer node P2 in which a network address IP/port is 192.168.2.202/1000 and in which a NAT address IP/port is 80.80.80.80/2048, and in which a virtual IP is 2.2.2.2 exist, tunnel information and route information of the peer node P1 may be set, as shown in Table 4.

TABLE 4

| Route | | Source | | Destination | |
|---|---|---|---|---|---|
| information | Virtual IP | IP | Port | IP | Port |
| 2,2,2,2/32 | 1.1.1.1 | 192.168.1.101 | 1000 | 80.80.80.80 | 2048 |

As shown in Table 4, tunnel information of the peer node P1 is {192.168.1.101/1000, 80.80.80.80/2048} as an IP/port corresponding to a source address of a tunnel and an IP/port corresponding to a destination address of a tunnel, and route information that is connected to the tunnel becomes 2.2.2.2/32, which is a virtual address of the peer node P2. In this case, when the peer node P2 is connected to the server 100, a destination address of a tunnel corresponds to a NAT address that is changed by the NAT 30. When such tunnel information and route information are set, if the peer node P1 transmits a packet to 2.2.2.2 as a destination, the packet passes through a tunnel using 80.80.80.80 as a destination.

Further, tunnel information and route information of the peer node P2 can be set, as shown in Table 5.

TABLE 5

| Route | | Source | | Destination | |
|---|---|---|---|---|---|
| information | Virtual IP | IP | Port | IP | Port |
| 1,1,1,1/32 | 2.2.2.2 | 192.168.2.202 | 1000 | 90.90.90.90 | 1024 |

As shown in Table 5, tunnel information of the peer node P2 is {192.168.2.202/1000, 90.90.90.90/1024} as an IP/port corresponding to a source address of a tunnel and an IP/port corresponding to a destination address of a tunnel, and route information that is connected to the tunnel becomes 1.1.1.1/32, which is a virtual address of the peer node P1. In this case, when the peer node P1 is connected to the server 100, a destination address of tunnel information corresponds to a NAT address that is changed by the NAT 20. When such tunnel information and route information are set, if the peer node P2 transmits a packet to 1.1.1.1 as a destination, the packet passes through a tunnel using 90.90.90.90/1024 as a destination.

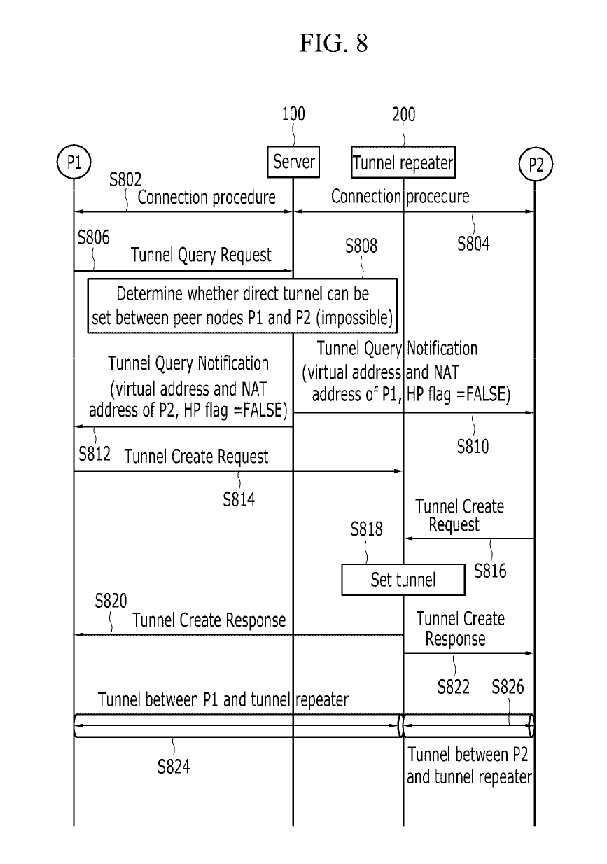

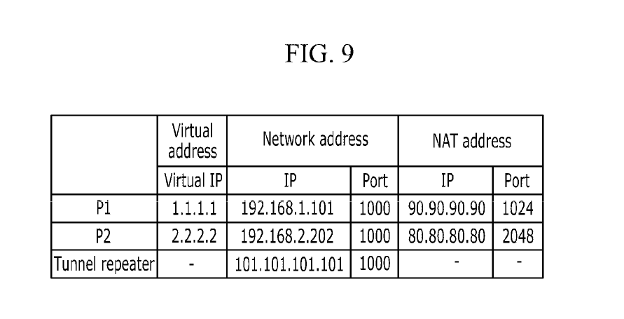

FIG. 8 is a flowchart illustrating a method in which two peer nodes set a tunnel with a tunnel repeater through a server according to an exemplary embodiment of the present invention, and FIG. 9 is a table illustrating an example of virtual addresses, network addresses, and NAT addresses of two peer nodes and an address of a tunnel repeater.

Referring to FIG. 8, the peer nodes P1 and P2 perform a connection procedure, as shown in FIG. 3 (S802-S804). Accordingly, the server 100 can acquire network addresses, NAT addresses, and network connection types of the peer nodes P1 and P2.

Thereafter, in order to perform direct communication with the peer node P2, the peer node P1 performs a process of setting a tunnel with the peer node P2.

In order to set a tunnel for performing direct communication with the peer node P2, the peer node P1 transmits a tunnel query request message to the server 100 (S806).

The server 100 having received a tunnel query request message determines whether a direct tunnel can be set between the peer nodes P1 and P2 from a network connection type of two peer nodes P1 and P2 (S808).

If a direct tunnel cannot be set between the peer nodes P1 and P2, the server 100 includes information in which a direct tunnel cannot be set between two peer nodes P1 and P2 and an address of the tunnel repeater 200 as tunnel information for allowing to set a tunnel with the tunnel repeater 200 in a tunnel query notification message, and transmits the message to the peer node P2 (S810). Further, the server 100 includes information in which a direct tunnel cannot be set between two peer nodes P1 and P2 and an address of the tunnel repeater 200 as tunnel information for allowing to seta tunnel with the tunnel repeater 200 in a tunnel query response message, and transmits the message to the peer node P1 (S812). Here, information in which a direct tunnel cannot be set between two peer nodes P1 and P2 can be represented by setting a hole punching flag. For example, by setting a hole punching flag to “FALSE”, information in which a direct tunnel cannot be set between two peer nodes P1 and P2 can be displayed. Further, tunnel information that is transmitted to the peer node P1 further includes a virtual address of the peer node P2 to communicate as well as an address of the tunnel repeater 200, and tunnel information that is transmitted to the peer node P2 further includes a virtual address of the peer node P1 to communicate as well as an address of the tunnel repeater 200.

The peer node P1, having received a tunnel query response message transmits a tunnel create request message including a virtual address thereof to an address of the tunnel repeater 200 as a destination (S814).

Further, the peer node P2, having received a tunnel create request message transmits a tunnel create request message including a virtual address thereof to an address of the tunnel repeater 200 as a destination (S816).

The tunnel repeater 200 having received a tunnel create request message from the peer nodes P1 and P2 sets a tunnel with the peer nodes P1 and P2 using a source address of the received tunnel create request message and an address thereof as tunnel information (S818). In this case, the source address of the tunnel create request message that is transmitted from the peer node P1 may be a NAT address of the peer node P1, and the source address of a tunnel create request message that is transmitted from the peer node P2 may be a NAT address of the peer node P2.

Specifically, the tunnel repeater 200 having received a tunnel create request message from the peer node P1 sets a tunnel using a source address of the tunnel create request message, i.e., a NAT address of the peer node P1 as a destination address, and using an address thereof as a source address.

Further, the tunnel repeater 200 having received a tunnel create request message from the peer node P2 sets a tunnel using a source address of a tunnel create request message, i.e., a NAT address of the peer node P2, as a destination address, and uses an address thereof as a source address. When the tunnel repeater 200 completes setting a tunnel with each of the peer nodes P1 and P2, the tunnel repeater 200 transmits a tunnel create response message to a tunnel create request message to each of the peer nodes P1 and P2 (S820-S822).

In this way, when a tunnel is set between the peer nodes P1 and P2 and the tunnel repeater 200, applications of the peer nodes P1 and P2 can perform direct communication based on a virtual IP with the tunnel repeater 200 through a predetermined tunnel (S824-S826).

Unlike an exemplary embodiment of the present invention, when a plurality of tunnel repeaters exist, the server 100 has a function of selecting a tunnel repeater to set a tunnel with the peer nodes P1 and P2 among a plurality of tunnel repeaters.

For example, as shown in FIG. 9, it is assumed that a peer node P1 in which a network address IP/port is 192.168.1.101/1000 and in which a NAT address IP/port is 90.90.90.90/1024, and in which a virtual IP is 1.1.1.1 and a peer node P2 in which a network address IP/port is 192.168.2.202/1000 and in which a NAT address IP/port is 80.80.80.80/2048 and in which a virtual IP is 2.2.2.2 exist, and an address IP/port of the tunnel repeater 200 is 101.101.101.101/1000. Accordingly, tunnel information and route information of the peer node P1 can be set, as shown in Table 6.

TABLE 6

| Route | Virtual | Source | | Destination | |
|---|---|---|---|---|---|
| information | IP | IP | Port | IP | Port |
| 2,2,2,2/32 | 1.1.1.1 | 192.168.1.101 | 1000 | 101.101.101.101 | 1000 |

Further, tunnel information and route information of the peer node P2 can be set, as shown in Table 7.

TABLE 7

| Route | Virtual | Source | | Destination | |
|---|---|---|---|---|---|
| information | IP | IP | Port | IP | Port |
| 1,1,1,1/32 | 2.2.2.2 | 192.168.2.202 | 1000 | 101.101.101.101 | 1000 |

As shown in Tables 6 and 7, in tunnel information of the peer node P1, a destination address becomes an address of the tunnel repeater 200, and in tunnel information of the peer node P2, a destination address becomes an address of the tunnel repeater 200.

Further, tunnel information and route information of the tunnel repeater 200 can be set, as shown in Table 8.

TABLE 8

| Route | Source | | Destination | |
|---|---|---|---|---|
| information | IP | Port | IP | Port |
| 1,1,1,1/32 | 101.101.101.101 | 1000 | 90.90.90.90 | 1024 |
| 2,2,2,2/32 | 101.101.101.101 | 1000 | 80.80.80.80 | 2048 |

As shown in Table 8, the tunnel repeater 200 sets a tunnel with each of the peer nodes P1 and P2, and thus the tunnel repeater 200 has tunnel information and route information about a tunnel that is set with the peer node P1 and has tunnel information and route information about a tunnel that is set with the peer node P2.

As in Tables 6 to 8, when tunnel information and route information are set, if a packet is transmitted from the peer node P1 to 2.2.2.2, which is a virtual IP of the peer node P2, the packet passes through a tunnel that is set between the peer node P1 and the tunnel repeater 200 and is transferred to the tunnel repeater 200. The tunnel repeater 200 having received a packet through a tunnel that is set between the peer node P1 and the tunnel repeater 200 determines a destination address of the received packet. In this case, because a destination address of the received packet is 2.2.2.2, which is a virtual IP of the peer node P2, the tunnel repeater 200 transmits the packet through a tunnel that is set between the peer node P2 and the tunnel repeater 200. Accordingly, the packet passes through a tunnel that is set between the peer node P2 and the tunnel repeater 200 and is transferred to the peer node P2.

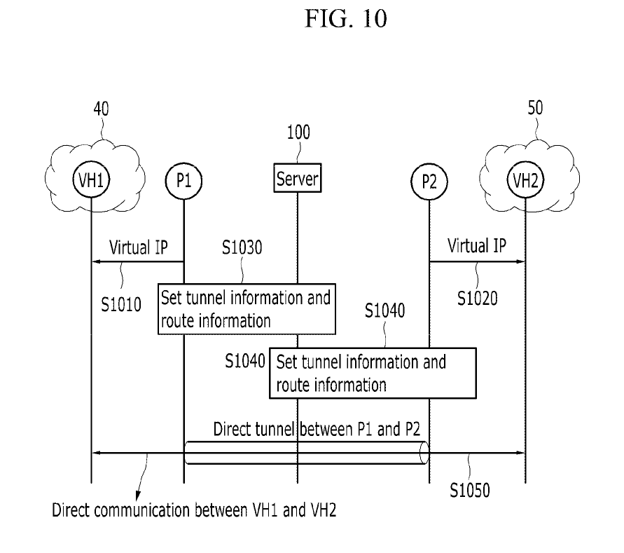

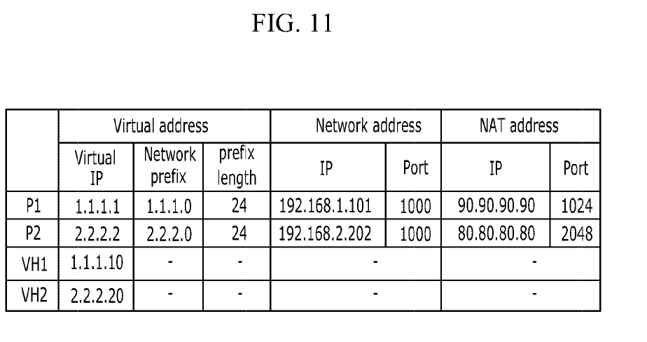

FIG. 10 is a flowchart illustrating a direct communication method between virtual hosts according to an exemplary embodiment of the present invention, and FIG. 11 is a table illustrating addresses of virtual networks in which two peer nodes exist. In FIG. 10, for convenience of description, it is assumed that the peer nodes P1 and P2 are connected to Public-Open.

Referring to FIG. 10, when the peer nodes P1 and P2 have a virtual network thereof, virtual hosts VH1 and VH2 exist in the virtual network. Direct communication can be performed between virtual hosts VH1 and VH2 through a method similar to a method of providing direct communication between the peer nodes P1 and P2.

For direct communication between virtual hosts VH1 and VH2 connecting to a virtual network in which the peer nodes P1 and P2 exist, the peer nodes P1 and P2 allocate virtual IPs to the virtual hosts VH1 and VH2, respectively, (S1010-S1020). In this case, the peer nodes P1 and P2 allocate a virtual IP to the virtual hosts VH1 and VH2 based on a network prefix and a prefix length that are received from the server 100. For example, when a network prefix and a prefix length are 1:1.1.0 and 24, respectively, the peer nodes P1 and P2 allocate a virtual IP between 1.1.1.1 and 1.1.1.255 to the virtual hosts VH1 and VH2, respectively.

Further, the peer nodes P1 and P2 set tunnel information and route information through methods that are shown in FIG. 6 or 8 (S1030-S1040). In this case, the peer node P1/P2 adds a network prefix and a prefix length of the correspondent peer node P2/P1 to a tunnel that is set using route information. Thereby, the virtual host VH1 of the peer node P1 and the virtual host VH2 of the peer node P2 perform direct communication through a tunnel that is set between the peer nodes P1 and P2 or through a tunnel that is set between the peer nodes P1 and P2 and the tunnel repeater 200 (S1050). FIG. 10 illustrates a direct tunnel that is set between the peer nodes P1 and P2.

For example, as shown in FIG. 11, it is assumed that the peer node P1 has a virtual network in which a network prefix and a prefix length are 1.1.1.0 and 24, respectively, the peer node P2 has a virtual network in which a network prefix and a prefix length are 2.2.2.0 and 24, respectively, a virtual IP of a virtual host VH of the virtual network in which the peer node P1 has is 1.1.1.10, and a virtual IP of a virtual host VH2 of the virtual network in which the peer node P2 has is 2.2.2.20. In this case, when direct communication can be performed between two peer nodes P1 and P2, tunnel information and route information of the peer node P1 can be set, as shown in Table 9, and tunnel information and route information of the peer node P2 can be set, as shown in Table 10.

TABLE 9

| Route | | Source | | Destination | |
|---|---|---|---|---|---|
| information | Virtual IP | IP | Port | IP | Port |
| 2,2,2,2/32 | 1.1.1.1 | 192.168.1.101 | 1000 | 80.80.80.80 | 2048 |
| 2,2,2,0/24 | | | | | |

TABLE 10

| Route | | Source | | Destination | |
|---|---|---|---|---|---|
| information | Virtual IP | IP | Port | IP | Port |
| 1,1,1,1/32 | 2.2.2.2 | 192.168.2.202 | 1000 | 90.90.90.90 | 1024 |
| 1,1,1,0/24 | | | | | |

In Tables 9 and 10, a network prefix and a prefix length of the correspondent peer node P2 are added to route information of the peer node P1, and a network prefix and a prefix length of the correspondent peer node P1 are added to route information of the peer node P2.

A method of providing direct communication between two peer nodes P1 and P2 may be embodied when a user performs signaling to a desired peer node at a necessary moment, and may be embodied by automatically signaling upon booting up a peer node according to a purpose to operate.

According to an exemplary embodiment of the present invention, in an IP network in which a firewall or a network address translation (NAT) exists, a direct communication environment between peer nodes through a direct tunnel between peer nodes is provided using a tunneling method that can perform direct communication between peer nodes, and when a direct tunnel between peer nodes cannot be set according to a network connection type, by providing a direct communication environment between peer nodes through a tunnel using a tunnel repeater, direct communication between peer nodes can be performed.

Further, by connecting a virtual address as route information to a predetermined tunnel, direct communication can be provided in a Layer 3 (L3) level between peer nodes, i.e., an IP level in which direct communication cannot be performed due to a firewall or a NAT.

Further, in order to perform IP communication in an IP network in which a firewall or a NAT exists, in the prior art, an intermediate for making a session that can perform direct communication, such as a session initiation protocol (SIP) on a service basis, is required, but according to an exemplary embodiment of the present invention, when a direct communication environment of an IP level is formed, it is unnecessary for each application service to form a special session and thus when operating each service, flexibility can be provided.

According to an exemplary embodiment of the present invention, direct communication between Peer-to-Peer (P2P), between Peer-to-Network (P2N), or between Network-to-Network (N2N) can be performed through interlocking with a peer node having a virtual network. This is very effective for constructing a service environment such as a game or P2P. Particularly, an existing application can be used for constructing a direct communication environment for a remote desktop, a video camera, a sensor device, or a service such as another remote control.

Further, as an IP network is applied to a network for a specific user group that forms a virtual network and that uses a virtual IP, or a device group such as a video camera or a sensor, direct communication may be performed.

An exemplary embodiment of the present invention may not only be embodied through the above-described apparatus and/or method, but may also be embodied through a program that executes a function corresponding to a configuration of the exemplary embodiment of the present invention or through a recording medium on which the program is recorded, and can be easily embodied by a person of ordinary skill in the art from the description of the foregoing exemplary embodiment.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method in which a peer node performs direct communication with a correspondent peer node in an Internet Protocol (IP) network, the method comprising:
receiving a virtual address of the peer node from a server;
transmitting a tunnel request message including an identifier of the correspondent peer node to the server;
receiving a tunnel response message including a virtual address of the correspondent peer node corresponding to the identifier of the correspondent peer node from the server;
setting a tunnel with the correspondent peer node; and
connecting the virtual address of the correspondent peer node as route information to the tunnel.

2. The method of claim 1, wherein the tunnel response message comprises a hole punching flag representing whether the peer node can perform direct communication with the correspondent peer node, and
the setting of the tunnel comprises directly setting, if the peer node can perform direct communication with the correspondent peer node by the hole punching flag, the tunnel with the correspondent peer node.

3. The method of claim 2, wherein the tunnel response message further comprises tunnel information for directly setting the tunnel, and
the directly setting of the tunnel comprises:
determining whether the tunnel information is useful; and
directly setting the tunnel with the correspondent peer node using the useful tunnel information.

4. The method of claim 3, wherein the determining of whether the tunnel information is useful comprises:
exchanging a message for a TCP or UDP hole punching with the correspondent peer node using tunnel information of the another peer node;
extracting, when a message is received from the correspondent peer node through exchange of a message, a source address from an IP header of the message; and
determining, when the tunnel information agrees with the source address, the tunnel information as the useful tunnel information.

5. The method of claim 3, wherein the peer node and the correspondent peer node are connected to a network address translation (NAT), and
the tunnel information comprises an address of the correspondent peer node that is changed by the NAT.

6. The method of claim 2, wherein the setting of the tunnel further comprises setting, if the peer node cannot perform direct communication with the correspondent peer node by the hole punching flag, the tunnel through a tunnel repeater.

7. The method of claim 6, wherein the tunnel response message further comprises an address of the tunnel repeater, and
the setting of the tunnel through the tunnel repeater comprises setting the tunnel using the address of the tunnel repeater as a destination.

8. The method of claim 7, wherein the setting of the tunnel through the tunnel repeater further comprises transmitting a tunnel setting request message including a virtual address of the peer node to the tunnel repeater using the address of the tunnel repeater as a destination, and
the tunnel repeater sets the tunnel using a source address of the tunnel setting request message as a destination and is connected to the tunnel using the virtual address of the peer node as route information.

9. The method of claim 1, wherein the virtual address comprises a virtual IP.

10. The method of claim 9, wherein when the correspondent peer node has a virtual network, the virtual address further comprises a network prefix and a prefix length, and
the connecting of the virtual address of the correspondent peer node comprises additionally connecting the network prefix and the prefix length as the route information.

11. The method of claim 10, further comprising allocating, when the peer node has a virtual network, a virtual IP to a virtual host that is connected to the virtual network based on a network prefix and a prefix length that are received from the server.

12. A method in which a server provides direct communication between two peer nodes in an IP network, the method comprising:
determining a network connection type of the two peer nodes;
determining whether direct communication can be performed between the two peer nodes from the network connection type of the two peer nodes;
transmitting, if direct communication can be performed between the two peer nodes, tunnel information corresponding to a destination of a tunnel to the two peer nodes in order to set the tunnel between the two peer nodes; and
transmitting a virtual address of a correspondent peer node to communicate as route information to connect to the tunnel to each of the two peer nodes.

13. The method of claim 12, further comprising transmitting, if direct communication cannot be performed between the two peer nodes, an address of a tunnel repeater to each of the two peer nodes so that the two peer nodes set the tunnel through the tunnel repeater.

14. The method of claim 12, wherein when the two peer nodes are connected to a network address translation (NAT), the tunnel information comprises addresses of the two peer nodes that are changed by the NAT.

15. The method of claim 12, further comprising:
receiving a registration request comprising identifiers of each of the two peer nodes from the two peer nodes;
determining whether the two peer nodes received the registration request, are end hosts or devices having a network; and
allocating a virtual IP as the virtual address to a peer node corresponding to the end host among the two peer nodes.

16. The method of claim 15, further comprising allocating a network prefix and a prefix length as well as the virtual IP as the virtual address to a peer node corresponding to the device having the network among the two peer nodes.

17. The method of claim 12, wherein the determining of whether direct communication can be performed between the two peer nodes comprises determining, when the network connection type of the two peer nodes is NAT-Symmetric and NAT-Symmetric, NAT-Symmetric and Public-Firewall, and NAT-Symmetric and NAT-Port Restricted Cone, that direct tunnel cannot be performed between the two peer nodes.

18. A method in which a tunnel repeater provides direct communication of two peer nodes in an IP network, the method comprising:
receiving a first tunnel setting request message including a virtual address of a first peer node from the first peer node of the two peer nodes;
receiving a second tunnel setting request message including a virtual address of a second peer node from the second peer node of the two peer nodes;
extracting source addresses of the first and second tunnel setting request messages;
setting a first tunnel using the source address of the first tunnel setting request message as a destination;
setting a second tunnel using the source address of the second tunnel setting request message as a destination;
connecting the virtual address of the first peer node as route information to the first tunnel; and
connecting the virtual address of the second peer node as route information to the second tunnel.

19. The method of claim 18, wherein when the first and second peer nodes are connected to a network address translation (NAT), and the source addresses of the first and second tunnel setting request messages are addresses of the two peer nodes that are changed by the NAT.

20. The method of claim 18, wherein the virtual address of a peer node corresponding to an end host among the two peer nodes comprises a virtual IP, and the virtual address of a peer node corresponding to a device having a network among the two peer nodes comprises a network prefix and a prefix length as well as the virtual IP.
